(19) United States
(12) Patent Application Publication
(10) Pub. No.: US 2011/0055809 A1
(43) Pub. Date: Mar. 3, 2011

(54) TYPED CONFIGURATION MANAGEMENT IN PROGRAMMING LANGUAGES

(75) Inventor: Joshua M. Woods, Durham, NC (US)

(73) Assignee: International Business Machines Corporation, Armonk, NY (US)

(21) Appl. No.: 12/549,813

(22) Filed: Aug. 28, 2009

(51) Int. Cl. G06F 9/44

(52) U.S. Cl. 717/120

(57) ABSTRACT

A typed configuration management method includes instantiating a typed configuration structure including parameters configured to store values. Each of the parameters includes a data type. The method also includes initializing an application on a computer system that includes the typed configuration structure, loading the values from the typed configuration structure into system memory of the computer system, and applying validation logic to the values to determine whether the values match corresponding data types specified for the parameters. In response to the determination, the method includes storing values that pass the validation logic in the parameters of the typed configuration structure, and loading the typed configuration structure, including the values passing the validation logic, into the system memory. Another method provides compile time loading and validation of a typed configuration structure, as well as compile time checking of program code that will use the typed configuration structure at runtime.

### BACKGROUND

The present disclosure relates generally to computer programming and, in particular, to typed configuration management in computer programming languages.

In a computer programming or software development environment, components, which are self-contained blocks of programming code, are often used and reused in order to decrease the overall size and complexity of the program under development, thereby enabling increased efficiencies in the overall development process. As component reuse becomes more widespread, an increasing amount of configuration is needed due to the generalized nature of these components. Oftentimes, this leads to a myriad of properties files, which at best may be well documented, loosely typed, and namespaced by convention only. In modem languages, such as Sun Microsystems® Java™, property file mechanisms provide little flexibility for pre-compiled libraries. For instance, in Java™ the properties file must be referenced absolutely, which leads to either hard-coded property file names and locations (or alteration of the classpath), or a non-standard solution to specify property file locations.

By contrast, a custom configuration system may be employed, which typically relies on an XML (eXtensible Markup Language) document as input to the system library. While this solution may offer type safety and some increased flexibility, it is not suitable for certain environments. For example, as the location of the document file needs to be fixed or specified, this can become problematic when employed inside of a web container, where modification of the configuration file requires redeployment of the application. In addition, the custom configuration solution lacks tight coupling between the properties and the implementation, which may ultimately lead to deficiencies when the documentation and the implementation fall out of sync. Further, custom configuration may be too burdensome for certain projects (e.g., small-scale projects) and is not well integrated into modem general-purpose languages (e.g., in some web-centric languages, XML documents are a type, but in Java and C#, they are not a type).

What is needed, therefore, is a way to support component reuse in a programming environment while minimizing associated configuration efforts.

### BRIEF SUMMARY

Embodiments of the invention include methods for implementing typed configuration management as part of a programming language. The method includes instantiating a typed configuration structure including parameters configured to store values, each of the parameters comprising a data type. The method also includes initializing an application on a computer system. The application includes the typed configuration structure. The method further includes loading the values from the typed configuration structure into system memory of the computer system, and applying validation logic to the values to determine whether the values match corresponding data types specified for the parameters. In response to the determination, the method includes storing values that pass the validation logic in the parameters of the typed configuration structure, and loading the typed configuration structure, including the values passing the validation logic, into the system memory.

Further embodiments include a system for implementing typed configuration management. The system includes a host system and an application executing on the host system. The application implements a method. The method includes instantiating a typed configuration structure including parameters configured to store values, each of the parameters comprising a data type. The method also includes initializing an application on a computer system. The application includes the typed configuration structure. The method further includes loading the values from the typed configuration structure into system memory of the computer system, and applying validation logic to the values to determine whether the values match corresponding data types specified for the parameters. In response to the determination, the method includes storing values that pass the validation logic in the parameters of the typed configuration structure, and loading the typed configuration structure, including the values passing the validation logic, into the system memory.

Further embodiments include a computer program product for implementing typed configuration management. The computer program product includes a computer readable storage medium having computer readable program code embodied therewith, the computer readable program code configured to implement a method. The method includes instantiating a typed configuration structure including parameters configured to store values, each of the parameters comprising a data type. The method also includes initializing an application on a computer system. The application includes the typed configuration structure. The method further includes loading the values from the typed configuration structure into system memory of the computer system, and applying validation logic to the values to determine whether the values match corresponding data types specified for the parameters. In response to the determination, the method includes storing values that pass the validation logic in the parameters of the typed configuration structure, and loading the typed configuration structure, including the values passing the validation logic, into the system memory.

Further embodiments include a method for implementing typed configuration management as part of programming language logic. The method includes instantiating a typed configuration structure including parameters configured to store values. Each of the parameters includes a data type and a read only property. The read only property signifies that one or more of the values are modifiable. The method includes loading source code of an application into a computer system memory, and compiling the source code into machine code. The source code contains code that retrieves the values from the typed configuration structure and stores them in variables. Each of the variables is configured to maintain the same value for the duration of the execution of the machine code. The method also includes checking the read only property corresponding to the value that is set in the variable, halting the compiling when the read only property indicates that the value is modifiable, returning a compilation error.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a portion of system upon which typed configuration management processes may be implemented at a linguistic level in exemplary embodiments;

FIG. 2 is a block diagram depicting a typed configuration structure utilized in implementing the typed configuration management processes in exemplary embodiments; and

FIG. 3 is a flow diagram describing a process for implementing the typed configuration management in accordance with exemplary embodiments.

The detailed description explains the preferred embodiments of the invention, together with advantages and features, by way of example with reference to the drawings.

### DETAILED DESCRIPTION

Methods, systems, and computer program products for implementing typed configuration management are provided in exemplary embodiments. The typed configuration management provides a typed configuration structure and process that may be implemented as part of a programming language. Application of the typed configuration structure (also referred to herein as “configuration structure” or “structure”) and process to a program language enables an end-user (e.g., a software developer) to facilitate and manage reuse of program components while minimizing associated configuration activities.

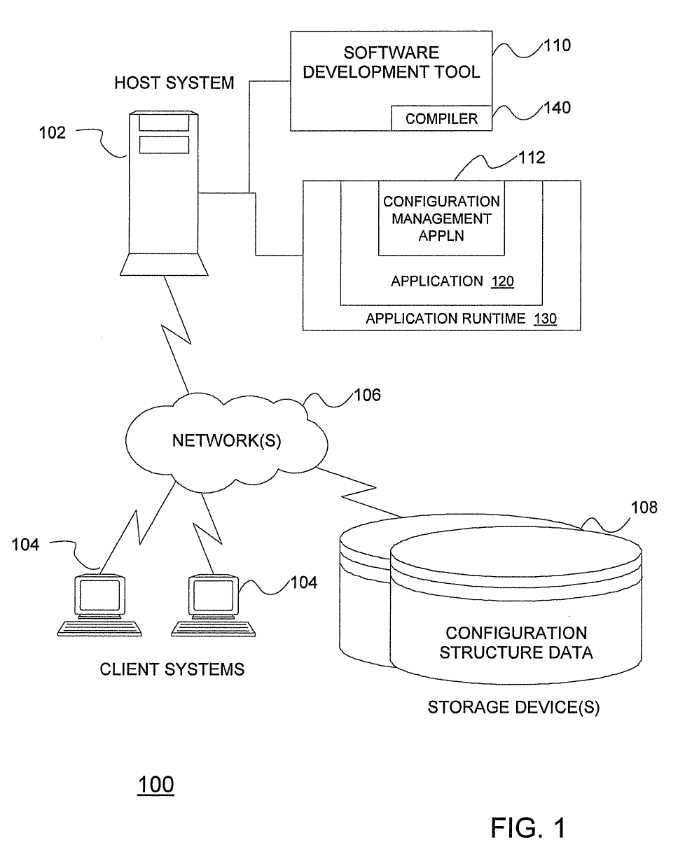

Turning now to FIG. 1, a system 100 for implementing the typed configuration management will now be described. In an exemplary embodiment, the system 100 includes a host system 102 executing computer instructions for performing typed configuration management at a programming language level (e.g., Java™). Host system 102 may operate in any type of environment that is capable of executing a software application. For example, the environment may include a UNIX server farm consisting of a plurality of servers, each of which executes an instance of an application that utilizes the typed configuration structure and process. Host system 102 may comprise a high-speed computer processing device, such as a mainframe computer, to manage the volume of operations governed by an entity for which the typed configuration management is executing. In one exemplary embodiment, the host system 102 may be part of an enterprise (e.g., a commercial business) that implements the typed configuration management.

In an exemplary embodiment, the system 100 depicted in FIG. 1 includes one or more client systems 104 through which users at one or more geographic locations may contact the host system 102. The client systems 104 are coupled to the host system 102 via one or more networks 106. Each client system 104 may be implemented using a general-purpose computer executing a computer program for carrying out the processes described herein. The client systems 104 may be personal computers (e.g., a lap top, a personal digital assistant) or host attached terminals. If the client systems 104 are personal computers, the processing described herein may be shared by a client system 104 and the host system 102 (e.g., by providing an applet to the client system 104). Client systems 104 may be operated by authorized users (e.g., programmers) of the typed configuration management processes described herein.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. A client system 104 may be coupled to the host system 102 through multiple networks (e.g., intranet and Internet) so that not all client systems 104 are coupled to the host system 102 through the same network. One or more of the client systems 104 and the host system 102 may be connected to the networks 106 in a wireless fashion. In one embodiment, the networks include an intranet and one or more client systems 104 execute a user interface application (e.g., a web browser) to contact the host system 102 through the networks 106. In another exemplary embodiment, the client system 104 is connected directly (i.e., not through the networks 106) to the host system 102 and the host system 102 contains memory for storing data in support of the typed configuration management. Alternatively, a separate storage device (e.g., storage device 108) may be implemented for this purpose.

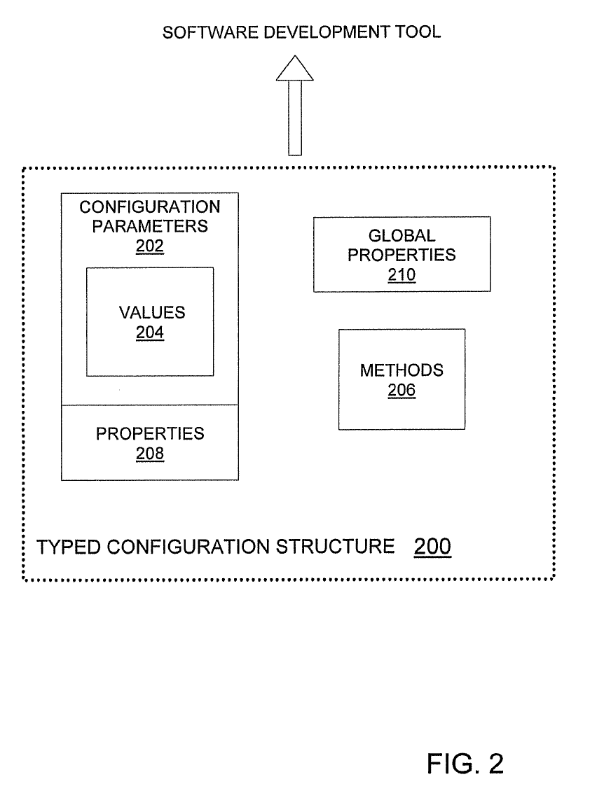

The storage device 108 includes a data repository with data relating to typed configuration management, as well as other data/information desired by the entity representing the host system 102 of FIG. 1. The storage device 108 is logically addressable as a consolidated data source across a distributed environment that includes networks 106. Information stored in the storage device 108 may be retrieved and manipulated via the host system 102 and/or the client systems 104. The data repository includes one or more databases containing, e.g., typed configuration structures and corresponding configuration parameters, values, methods, and properties, as well as other related information. The typed configuration structure is described further in FIG. 2. It will be understood by those of ordinary skill in the art that the data repository may also comprise other structures, such as an XML file on the file system or distributed over a network (e.g., one of networks 106), or from a data stream from another server located on a network. In addition, the storage device 108 may alternatively be located on a client system 104.

The host system 102 depicted in the system of FIG. 1 may be implemented using one or more servers operating in response to a computer program stored in a storage medium accessible by the server. The host system 102 may operate as a network server (e.g., a web server) to communicate with the client systems 104. The host system 102 handles sending and receiving information to and from the client systems 104 and can perform associated tasks. The host system 102 may also include a firewall to prevent unauthorized access to the host system 102 and enforce any limitations on authorized access. For instance, an administrator may have access to the entire system and have authority to modify portions of the system. A firewall may be implemented using conventional hardware and/or software as is known in the art.

The host system 102 may also operate as an application server. The host system 102 executes one or more computer programs to provide typed configuration management. The typed configuration management processes may be integrated within a software development tool 110 utilized by end users (e.g., client systems 104). Alternatively, the typed configuration management processes may be implemented independent of any particular programming language (i.e., program language agnostic), whereby a software application (not shown) provides the typed configuration management functions on top of one or more existing software development tools (e.g., using advanced annotations). As shown in FIG. 1, for purposes of illustration, the typed configuration management is implemented by an application 112 (also referred to as “configuration management application”) executing on the host system 102. The typed configuration management processes operate in a programming language environment that includes, for example, a run time environment 130 (e.g., software/services available to a program during its execution), as well as a compiler and/or interpreter 140. The software/services available to a program may be provided by an operating system, a virtual machine, and/or a collection of program libraries.

As indicated above, processing may be shared by the client systems 104 and the host system 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

It will be understood that the typed configuration management described in FIG. 1 may be implemented in hardware, software, or a combination thereof

As described above, the typed configuration management provides a configuration structure and process that may be implemented as part of a programming language. Turning now to FIG. 2, an exemplary typed configuration structure 200 will now be described. For illustrative purposes, the typed configuration structure 200 is represented as a class (e.g., a Java™ class); however it will be understood by those of ordinary skill in the art that the typed configuration structure 200 may be implemented using other programming languages and may be represented in various forms such as a native part of the programming language, or the application runtime 130. In one embodiment, the typed configuration structure 200 and process may be designed to operate as a standard part of a programming language.

In exemplary embodiments, the typed configuration structure 200 contains configuration parameters 202. The configuration parameters 202 contain values 204, and each value 204 is associated with a plurality of properties 208, as described further herein. In addition, in an exemplary embodiment, the typed configuration structure 200 contains associated methods 206 for accessing and setting the configuration parameter 202 values 204 and properties 208. The properties 208 may include, by way of non-limiting example, an algorithm for validating the data type or value of the data set in the configuration parameters 202, maximum values, minimum values, number of elements, a flag to indicate whether a value 204 is read only or modifiable, data types and other properties, including other typed configuration structures 200. A data type is an indication of the types of information the configuration parameters 202 can hold (i.e., an integer, a decimal number, a date, and a character, among others). In addition, the typed configuration structure 200 may maintain global properties 210, such as, the time the class was loaded into the program memory, a property to indicate the typed configuration structure 200 is in read only mode, locations of default configuration values 204, including other typed configuration structures 200, and other properties as would be understood by those of ordinary skill in the art. The typed configuration structure 200 may be extended to add values and properties that are specific to an application. The typed configuration structure 200 may also be overridden, such that default methods 206, values 204 and properties 208 are replaced by a new set of values.

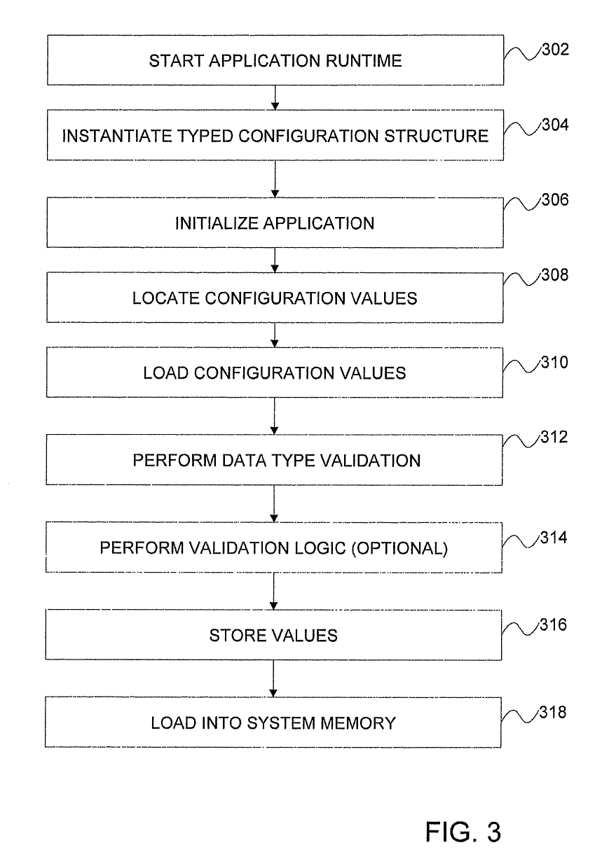

Turning now to FIG. 3, an exemplary process for implementing the typed configuration management will now be described. At step 302, an application runtime 130 is started for a selected application (e.g., application 120 of FIG. 1). The application runtime 130 may be started using a virtual machine or by any other suitable method for initiating the start of application execution. At step 304, the application runtime environment 130, a class loader in Java™, for example, instantiates the typed configuration structure 200. In an alternative exemplary embodiment, where the typed configuration is part of the programming language, the runtime environment 130 may initialize the typed configuration structure 200 directly. Once the configuration structure 200 is initialized and any other preliminary initialization procedures of the programming language or operating system have completed, the application specific portion of the source code of the application 120 is initialized at step 306. The runtime environment 130 then locates the configuration values 204 at step 308 as further described herein.

Once the configuration values 204 are located, they are loaded into memory (e.g., memory of the host system 102) at step 310. At step 312, the runtime environment 130 performs data type validation, which is also described further herein. If applicable, the configuration management application 112 executes any parameter specific validation logic loaded in the properties 208 at step 314. If the values 204 pass the validation (i.e., the validation from step 312 and, optionally from step 314 if applicable), the values 204 are stored in the configuration parameters 202 in the typed configuration structure 200 at step 316. Upon completion of loading configuration values 204 into the configuration parameters 202, the typed configuration structure 200 is loaded into system memory along with the remaining runtime structure at step 318.

A process for locating the configuration values 204 by the runtime environment 130 (from step 308) will now be described in an exemplary embodiment. The configuration management application 112 may be configured to load an initial configuration from a source (e.g., an XML file on the storage device 108 or distributed over a network (e.g., one of networks 106), from a database table in storage device 108, or from a data stream from another server located on another network (not shown)). The typed configuration structure 200 may include global properties 210 that may be set to determine if, at runtime, the configuration management application 112 should check for configuration changes from the initial source (e.g., storage device 108), or from a new source (not shown). The typed configuration structure 200 may also include configuration value properties 208 that would enable the configuration management application 112 to check for changes from the initial source (e.g., storage device 108) for each configuration value 204 in the typed configuration structure 200 individually. In an exemplary embodiment, the configuration management application 112 may be configured to check for changes from the initial source (e.g., storage device 108) at predetermined intervals, such that when a value 204 is changed at the source, the configuration parameters 202 and the properties 208 are reloaded with the changes from the source.

The configuration management application 112 may also be set to check for changes at specific intervals at the global level, such that all configuration parameters 202, and properties 208 are reloaded when a change is detected or at the individual configuration parameters 202 and properties 208 level, such that only certain configuration parameters 202 and properties 208 are reloaded when a change is detected. The various check and interval values may be set at compile time, or alternatively, at runtime using the methods 206, properties 208, or a combination of the two.

An exemplary validation process (steps 312/314) will now be described. At compile time, a compiler may check the typed configuration structure 200 to identify any configuration values 204 that do not meet requirements of the validation logic. The validation logic may check for certain criteria such as data type, length, value limits, and other similar properties as defined in the properties 208. The validation logic may also use other values as part of the validation determination, for example, to determine if the value of one configuration parameter 202 is between the values of two other configuration parameters 202. If any values do not meet the validation logic requirements, the compiler may exit and provide an error.

At compile time, the compiler 140 may also check the typed configuration structure 200 to identify if any of the configuration parameter values 204 can be changed at runtime. If any of the parameter values 204 are changed at runtime the complier 140, while compiling the source code, may check for the use of the changeable configuration parameters 202 in the source code to be compiled and, if the changeable configuration parameters 202 are used in a way that may create a disruption, or unpredictable behavior at runtime (e.g., where a static variable is loaded with a changeable configuration parameter value), the compiler 140 may issue an error and halt compilation or, alternatively, the compiler 140 may issue a warning and continue the compilation process. The error and warning may be returned to a log file stored on a file system 108, or the file system within the host system 102, or on the file storage of the client system 104. In addition, the error or warning may be displayed on a monitor or other display device attached to the client system 104, or the host system 102.

In another exemplary embodiment, the configuration parameters 202 may be set at runtime. The configuration parameters 202 may be set by a call to a method 206, or the parameters 202 may be adjusted through an XML file on the file system or distributed over a network, a database table, or another server located on a network. Where the parameters 202 are configured at runtime through an XML file, the configuration management application 112 may be configured to detect which individual parameter 202 has changed in the XML file and set only that single parameter 202 as opposed to resetting all parameters of the typed configuration. In addition, the configuration management application 112 may be configured such that an individual configuration parameter value 204 or property 208 may be passed in via an XML stream over a network. The configuration management application 112 may also be configured to monitor a database (e.g., in storage device 108) for changes in parameter values 204 and properties 208 and to update the configuration parameters 202 whenever the database values change. The configuration management application 112 may also be configured to monitor and read parameters from a file system of storage device 108, and to monitor the file system for changes to the parameter values 204, and load those new parameter values 204 when they have changed.

As described above, the configuration management application 112 may be configured to receive changes to parameters 202 from another server or application over the network. The configuration management application 112 may be configured to either receive the configuration parameter value 204 and property 208 changes as a request from another server or application, or to request or poll a server or application over the network for changes at intervals. The interval period may be configured as discussed above.

When the configuration parameter values 204 are changed at runtime using any of the above-described embodiments, or by any other mechanism, the configuration management application 112 may perform validation on the data using a validation algorithm, data type, or any other information contained in the properties 208 (e.g., as described in steps 312/314 of FIG. 3). If the new value passes validation, the configuration management application 112 may update the appropriate configuration parameter 202. If the new value does not pass validation, the configuration management application 112 may return a validation error. Alternatively, the configuration management application 112 may be configured to throw a runtime error, or, trigger the application to terminate execution. The configuration management application 112 may also be configured to provide a warning, either by a log message, or other mechanism such as, for example, displaying it on a monitor or other display device, and ignore the new configuration value.

In a further exemplary embodiment, an application may be compiled such that a typed configuration structure 200 is included in compiled code (e.g., as an application, such as 120). The typed configuration structure 200 contains a plurality of predefined configuration parameters 202. These predefined configuration parameters 202 may be defined by a vendor, or they may be defined globally by a standards body and incorporated into the programming language as a standard convention. A vendor, or other application provider, may then distribute the application 120 to a plurality of third parties. The third parties may then set their own initial configuration parameter values 204 using, for example, an XML file on the file system or distributed over a network, a database table, or another server located on a network. When configured with the typed configuration structure 200, the application 120 may be automatically initiated with the initial values provided by the plurality of third parties without any further intervention by the vendor or the third parties. In this way, each third party may pre-configure the application 120, in a standard format, without requiring a recompilation of the application 120. This is beneficial because it lowers the cost of custom distribution by the vendors and does not require the distribution of the source code to third parties.

In yet another exemplary embodiment, the configuration management application 112 may be configured to communicate with other applications in server farm (not shown). A server farm comprises several servers executing the same application, and the servers are in communication with one another over a network. The configuration management application 112 may be configured such that one server is the main configuration server and the remaining servers are secondary servers. The servers may be configured such that the main server is predefined or selected dynamically as described herein.

If the main server is to be selected dynamically, when application 120 is started, the configuration management application 112 searches the network for a main configuration server. If the main configuration server is not located, the server classifies itself as a main server and sets the typed configuration parameter values 204 and properties 208 from a default location. If the main configuration server is found, the server becomes a secondary server for purposes of configuration and requests configuration values from the main server. The main configuration server is configured to communicate over a network to the secondary servers. When a configuration parameter value 204 changes on the main server, the main server communicates the changed value over the network to the secondary servers. This may be accomplished through a network broadcast means, such as Universal Datagram Protocol (UDP) or other connectionless mechanisms, or through a connection based protocol (TCP/IP for example) by maintaining a table of secondary servers and distributing the changes, for example by sending the changes to each server in the table. The table of secondary servers may be updated as each server comes online, or the table of secondary servers may be configured in advance.

If the main server is to be predefined, the secondary server may be configured to always request configuration settings from the main server. In addition, if the secondary server cannot find the main server, it may be configured to emulate the main server by load a configuration file from a default location, as described above.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for implementing typed configuration management as part of programming language logic, the method comprising:
instantiating a typed configuration structure including parameters configured to store values, each of the parameters comprising a data type;
initializing an application on a computer system, the application including the typed configuration structure;
loading the values from the typed configuration structure into system memory of the computer system;
applying validation logic to the values and determining whether the values match corresponding data types specified for the parameters;
responsive to the determining, storing values that pass the validation logic in the parameters of the typed configuration structure; and
loading the typed configuration structure, including the values passing the validation logic, into the system memory.

2. The method of claim 1, wherein the values are loaded from one of:
an XML file;
a database;
a flat file on a file system; and
a data stream from another computer system.

3. The method of claim 1, further comprising loading the validation logic corresponding properties from the typed configuration structure into the system memory, wherein the validation logic and corresponding properties are loaded with the values.

4. The method of claim 1, wherein upon determining that the values match corresponding data types specified for the parameters, triggering an error and halting application execution.

5. The method of claim 1, further comprising:
checking for changes to the values in the typed configuration structure at specific intervals, the checking performed prior to loading the values into the system memory.

6. The method of claim 1, further comprising:
checking for changes to the values in the typed configuration structure at specific intervals, the checking performed subsequent to loading the values into the system memory.

7. The method of claim 1, wherein the typed configuration structure is a class.

8. The method of claim 1, wherein the parameters further comprise:
functions for retrieving and setting the values; and
a read only property;
wherein the values are accessible solely via the functions, and the read only property signifies whether the values are modifiable.

9. A system for providing typed configuration management, comprising:
a host system computer; and
a configuration management application executing on the host system computer, the configuration management application implementing a method, comprising:
instantiating a typed configuration structure including parameters configured to store values, each of the parameters comprising a data type;
initializing an application on the host system computer, the application including the typed configuration structure;
loading the values from the typed configuration structure into system memory of the host system computer;
applying validation logic to the values and determining whether the values match corresponding data types specified for the parameters;
responsive to the determining, storing values that pass the validation logic in the parameters of the typed configuration structure; and
loading the typed configuration structure, including the values passing the validation logic, into the system memory.

10. The system of claim 9, wherein the values are loaded from one of:
an XML file;
a database;
a flat file on a file system; and
a data stream from another computer system.

11. The system of claim 9, wherein the configuration management application further implements:
loading the validation logic corresponding properties from the typed configuration structure into the system memory, wherein the validation logic and corresponding properties are loaded with the values.

12. The system of claim 9, wherein upon determining that the values match corresponding data types specified for the parameters, the configuration management application further implements:
triggering an error and halting application execution.

13. The system of claim 9, wherein the configuration management application further implements:
checking for changes to the values in the typed configuration structure at specific intervals, the checking performed prior to loading the values into the system memory.

14. The system of claim 9, wherein the configuration management application further implements:
checking for changes to the values in the typed configuration structure at specific intervals, the checking performed subsequent to loading the values into the system memory.

15. The system of claim 9, wherein the typed configuration structure is a class.

16. The system of claim 9, wherein the parameters further comprise:
functions for retrieving and setting the values; and
a read only property;
wherein the values are accessible solely via the functions, and the read only property signifies whether the values are modifiable.

17. A computer program product for providing typed configuration management, the computer program product including a computer readable storage medium having computer readable program code embodied therewith, the computer readable program code configured to implement:
instantiating a typed configuration structure including parameters configured to store values, each of the parameters comprising a data type;
initializing an application on a computer system, the application including the typed configuration structure;
loading the values from the typed configuration structure into system memory of the computer system;
applying validation logic to the values and determining whether the values match corresponding data types specified for the parameters;
responsive to the determining, storing values that pass the validation logic in the parameters of the typed configuration structure; and
loading the typed configuration structure, including the values passing the validation logic, into the system memory.

18. The computer program product of claim 16, wherein the values are loaded from one of:
an XML file;
a database;
a flat file on a file system; and
a data stream from another computer system.

19. The computer program product of claim 16, further comprising instructions for implementing:
loading the validation logic corresponding properties from the typed configuration structure into the system memory, wherein the validation logic and corresponding properties are loaded with the values.

20. The computer program product of claim 16, wherein upon determining that the values match corresponding data types specified for the parameters, triggering an error and halting application execution.

21. The computer program product of claim 16, further comprising instructions for implementing:
checking for changes to the values in the typed configuration structure at specific intervals, the checking performed prior to loading the values into the system memory.

22. The computer program product of claim 16, further comprising instructions for implementing:
checking for changes to the values in the typed configuration structure at specific intervals, the checking performed subsequent to loading the values into the system memory.

23. The computer program product of claim 16, wherein the typed configuration structure is a class.

24. The computer program product of claim 16, wherein the parameters further comprise:
functions for retrieving and setting the values; and
a read only property;
wherein the values are accessible solely via the functions, and the read only property signifies whether the values are modifiable.

25. A method for implementing typed configuration management as part of programming language logic, the method comprising:
instantiating a typed configuration structure including parameters configured to store values, each of the parameters comprising a data type and a read only property, wherein the read only property signifies that one or more of the values are modifiable;
loading source code of an application into computer system memory;
compiling the source code into machine code, the source code containing code that retrieves the values from the typed configuration structure and stores them in variables, each of the variables configured to maintain the same value for the duration of the execution of the machine code;
checking the read only property corresponding to the value that is set in the variable;
halting the compiling when the read only property indicates that the value is modifiable; and
returning a compilation error.
